(19) United States
(12) Patent Application Publication
(10) Pub. No.: US 2008/0007741 A1
(43) Pub. Date: Jan. 10, 2008

(54) Image processing setting device, image processing device, image forming system, image processing setting method, image processing method, and image forming method

(75) Inventors: Toshimi Shinchi, Tokyo (JP); Tamotsu Sakuraba, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/645,753

(22) Filed: Dec. 27, 2006

(30) Foreign Application Priority Data
Jul. 10, 2006 (JP) 2006-189442

(51) Int. Cl. G06F 3/12

(52) U.S. Cl. 358/1.1

(57) ABSTRACT

Disclosed herein is an image processing setting device including: a screen processing setting unit for setting, on a page-by-page basis, processing parameters for screen processing carried out in an image processing device.

### BACKGROUND OF THE INVENTION

1. Field of the Invention

The present invention relates to an image processing setting device, an image processing device, an image forming system, an image processing setting method, an image processing method, and an image forming method.

2. Description of Related Art

An image processing device for performing image processing of image data to be output to a recording medium such as paper has conventionally been configured to optimize image quality by executing image processing such as screen processing for the image data.

Recently, such an image processing device has been enabled to execute screen processing according to the types of objects in the image data instead of executing the same screen processing for the entire image data. For example, screen processings which are different between a binary line-drawing character object and a multilevel gradation image object can be executed (for example, refer to JP A 2004-94439).

However, when a plurality of pages of image data are output by the image processing device described in the aforementioned document, the same screen processing is carried out in all the pages for the objects of the same type. Thus, for example, in case that there is image data containing a plurality of photographs, when screen processing is executed to eliminate moire of a photograph of a certain page, a screen processing unmatched with an object may be executed depending on a page, such as a change in color of a photograph of another page. This problem is especially noticeable in the case of using a sheet of different quality for a front cover page.

To solve such a problem, a method of forming image data which are different from page to page in order to individually output them is available. In this case, however, the processing becomes more complex as the number of image data to be output is increased.

### SUMMARY

An object of the present invention is to provide an image processing setting device, an image processing device, an image forming system, an image processing setting method, an image processing method, and an image forming method, capable of executing the screen processing for each page without complicating the processing.

To achieve at least one of the above-described objects, an image processing setting device reflecting one aspect of the invention comprises:

a screen processing setting unit for setting, on a page-by-page basis, a processing parameter regarding screen processing carried out in an image processing device.

An image processing device reflecting another aspect of the invention comprises:

a parameter detecting unit for detecting, on a page-by-page basis, a processing parameter regarding screen processing; and

a screen processing unit for carrying out the screen processing for each page based on the processing parameter detected by the parameter detecting unit.

An image forming system reflecting one aspect of the invention comprises:

the above-described image processing setting device;

an image processing device which comprises a parameter detecting unit for detecting, on a page-by-page basis, the processing parameter regarding the screen processing, and a screen processing unit for carrying out the screen processing for each page based on the processing parameter detected by the parameter detecting unit; and

an image forming device for forming an image for which the screen processing has been carried out by the image processing device.

An image processing setting device reflecting one aspect of the invention comprises:

a screen processing setting unit for setting, on a page-by-page basis, a screen applied to screen processing carried out in an image processing device.

Preferably, in the image processing setting device, the screen processing setting unit sets the screen by assigning at least one of the number of screen lines, a screen angle, and a dot shape.

In this case, preferably, in the image processing setting device, the image processing setting device further comprises:

a display unit for displaying, on the page-by-page basis, at least one option regarding at least one of the number of screen lines, the screen angle, and the dot shape; and

an input unit for receiving a selecting operation of the at least one option from a user, wherein

the screen processing setting unit sets for each page the screen corresponding to the at least one option selected by the selecting operation.

### BRIEF DESCRIPTION OF THE DRAWINGS

The present invention will become fully understood by the detailed description and the accompanying drawings by a given by way of illustration only, and thus are not intended as a definition of the limits of the present invention, and wherein:

FIG. 1 is a conceptual diagram showing a schematic configuration of an image forming system according to the present invention;

FIG. 2 is a block diagram showing a schematic configuration of a client personal computer;

FIG. 3 is a block diagram showing a schematic configuration of an image forming device;

FIG. 4 is a block diagram showing a schematic configuration of a print controller;

FIG. 5 is a flowchart for explaining an operation of the client personal computer;

FIG. 6 is a flowchart explaining an operation of an image forming device;

FIG. 7 is a flowchart explaining an operation of an image forming device;

FIG. 8A is a diagram showing an input example of a screen processing parameter;

FIGS. 8B to 8D are diagrams showing output image examples;

FIG. 9 is a diagram showing a screen processing setting command;

FIG. 10A is a diagram showing an input example of a screen processing parameter;

FIGS. 10B to 10E are diagrams showing output image examples;

FIG. 11 is a diagram showing a screen processing setting command.

### DETAILED DESCRIPTION OF THE PREFERRED EMBODIMENT

Hereinafter, an embodiment of the present invention will be described with reference to the drawings.

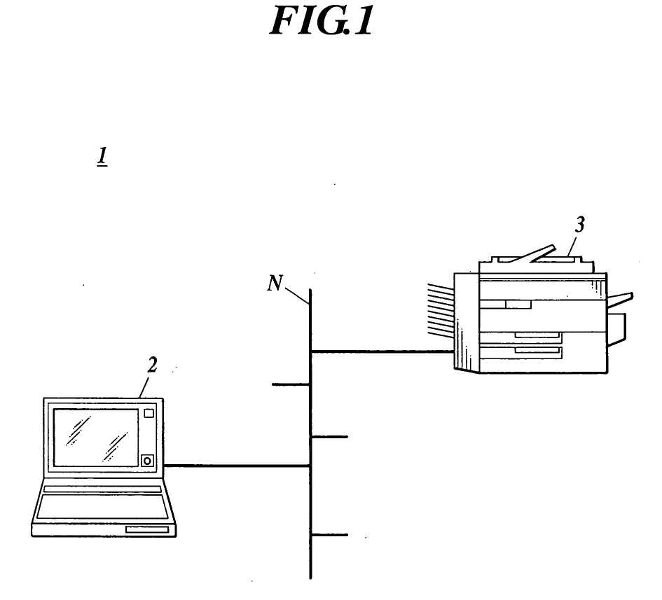

FIG. 1 is a diagram showing a schematic configuration of an image forming system 1 according to the present invention.

As shown in the drawing, the image forming system 1 comprises a client personal computer 2 and an image forming device 3 which are interconnected via a communication network N. The communication network N enables data transfer between the client personal computer 2 and the image forming device 3. The communication network N comprises a local area network (LAN) which interconnects computers and network devices by standards such as Ethernet (registered trademark), a token ring, a fiber distributed data interface (FDDI), or the like, for example, a wide area network (WAN) which connects LANs to each other by an exclusive line, or the like. The client personal computer 2 and the image forming device 3 may be interconnected via an interface which complies with a standard such as IEEE 1394 instead of the communication network N.

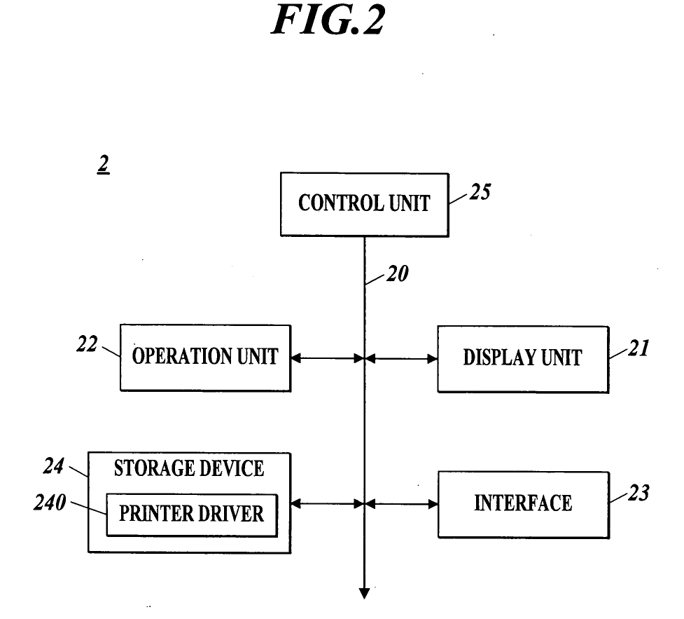

The client personal computer 2 is an image processing setting device according to the present invention, which comprises a display unit 21, an operation unit 22, an interface 23, a storage device 24, and a control unit 25 which are interconnected to each other via a bus 20 as shown in FIG. 2.

The display unit 21 comprises a liquid crystal display (LCD) or the like, and displays and outputs data and the like which are instructed by the control unit 25.

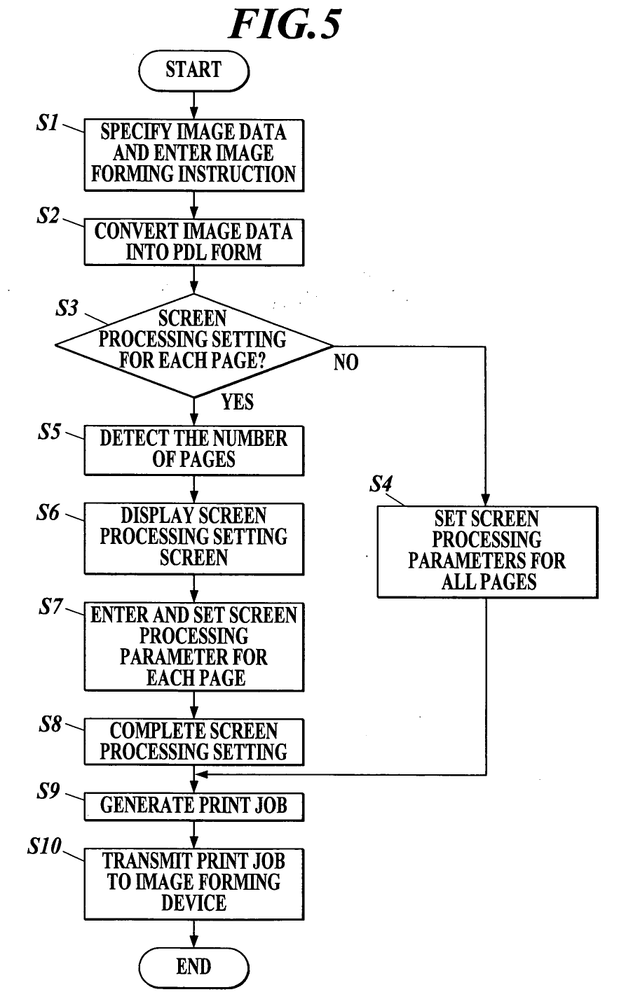

The operation unit 22 comprises a plurality of operation keys, and outputs an instruction input by a user to the control unit 25. More specifically, a screen processing parameter of the screen processing to be carried out in the image forming device 3 is input to the operation unit 22 in the after-mentioned image processing parameter setting processing (refer to FIG. 5). The screen processing means the execution of an image processing regarding a screen angle, the number of lines, and a dot shape of an output image.

The interface 23 enables communication between the communication network N and the client personal computer 2. According to the embodiment, a print job can be transmitted to the image forming device 3 via the communication network N.

The print job is data containing an image data regarding a text and an image, and a screen processing setting command corresponding to the screen processing parameter described above. According to the embodiment, a single print job is transmitted for a print having a plurality of pages.

The storage device 24 comprises a hard disk or the like, and stores data and program so that they are readable and writable. According to the embodiment, in addition to various types of application software for such as document preparation, table calculation, graphic drawing, and the like, a printer driver 240 is stored.

The printer driver 240 is software to set a function/operation of the image forming device 3. According to the embodiment, the printer driver 240 is executed by the control unit 25 to make the client personal computer 2 carry out the after-mentioned image processing parameter setting processing (refer to FIG. 5).

The control unit 25 controls each section of the client personal computer 2, and comprises a read only memory (ROM), a random access memory (RAM), a central processing unit (CPU), and the like which are omitted from the drawing.

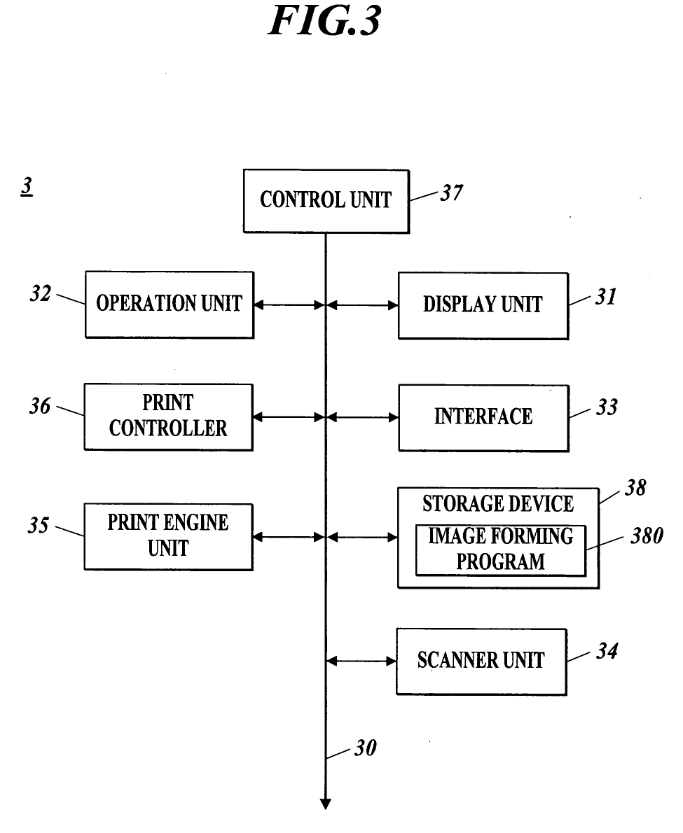

The image forming device 3 is an image processing device according to the present invention, which comprises a display unit 31, an operation unit 32, an interface 33, a scanner unit 34, a print engine unit 35, a print controller 36, a control unit 37, and a storage device 38 which are interconnected via a bus 30 as shown in FIG. 3.

The display unit 31 comprises a liquid crystal display (LCD) or the like, and displays and outputs an operation screen using a graphical user interface (GUI) and the data and the like which are instructed by the control unit 37. A touch panel of an electromagnetic induction type, a magnetostriction type, or a pressure-sensitive type may be formed in the display screen of the display unit 31. The touch panel is one for detecting the X-Y coordinate of a power point pressed by a finger or a touch pen by a lattice transparent electrode and outputting a detected position signal as an operation signal.

The operation unit 32 comprises a plurality of operation keys, and outputs the instruction input by a user to the control unit 37.

The interface 33 enables a communication between the communication network N and the image forming device 3.

The scanner unit 34 reads an image recorded in a recording medium such as paper to generate the image data. The image data generated by the scanner unit 34 contains image data of such as a figure and a photograph, text data of such as letters and symbols, and the like.

The print engine unit 35 forms an image on a recording medium such as paper by a predetermined printing method such as a laser beam method or an ink jet method.

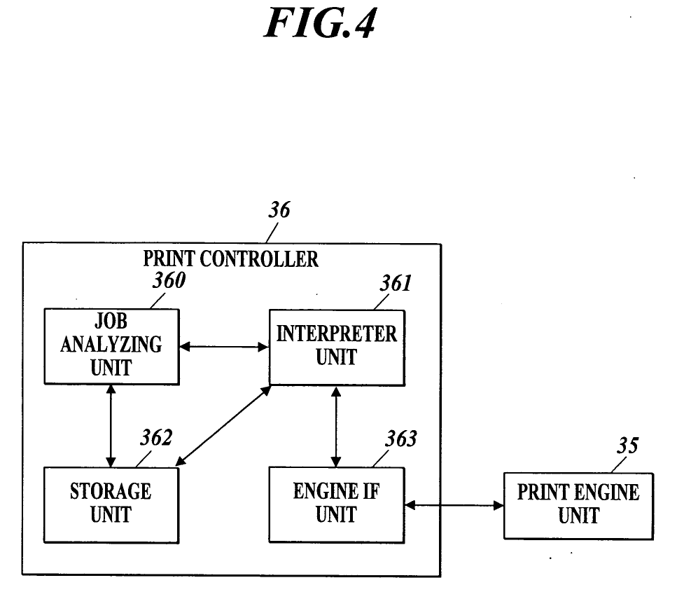

The print controller 36 drives the print engine unit 35 based on a print job, and comprises a job analyzing unit 360, an interpreter unit 361, a storage unit 362, and an interface (IF) unit 363 as shown in FIG. 4.

The job analyzing unit 360 analyzes the print job, and can detect a screen processing setting command for each page.

The interpreter unit 361 rasterizes the image data to convert it into a bitmap form. According to the embodiment, the interpreter unit 361 executes rasterization, and carries out the screen processing based on the screen processing setting command.

The storage unit 362 comprises a RAM and the like, and stores a default screen processing setting, a screen processing setting set by a user, image data, and the like.

The engine IF unit 363 transmits the image data rasterized by the interpreter unit 361 to the print engine unit 35.

As shown in FIG. 3, the control unit 37 controls each section of the image forming device 3, and comprises a read only memory (ROM), a random access memory (RAM), a central processing unit (CPU), and the like which are omitted from the drawing.

The storage device 38 comprises a hard disk which has larger storage capacity than the storage unit 362 of the print controller 36 and the like, and stores data and program so that they are readable and writable. According to the embodiment, the storage device 38 stores an image forming program 380 and temporarily saves the print job.

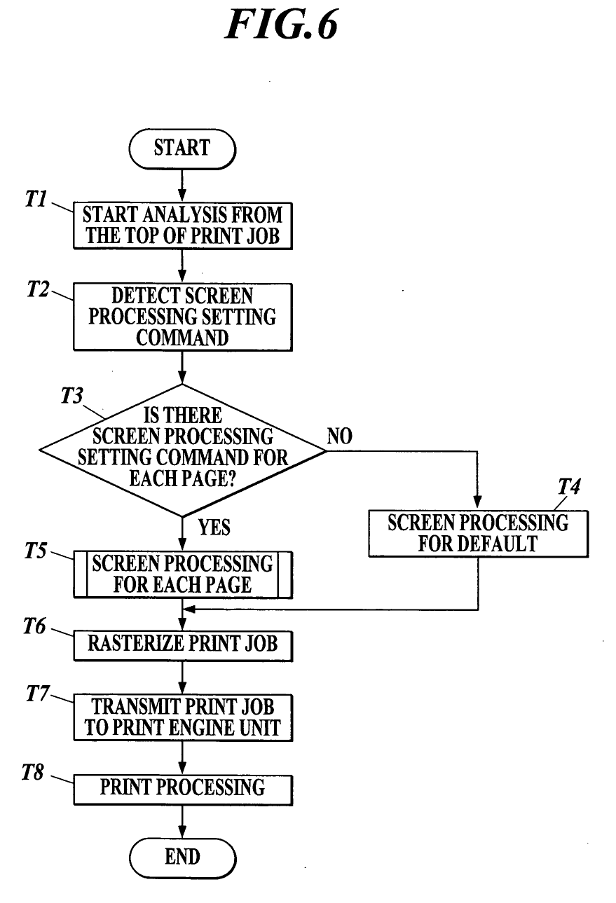

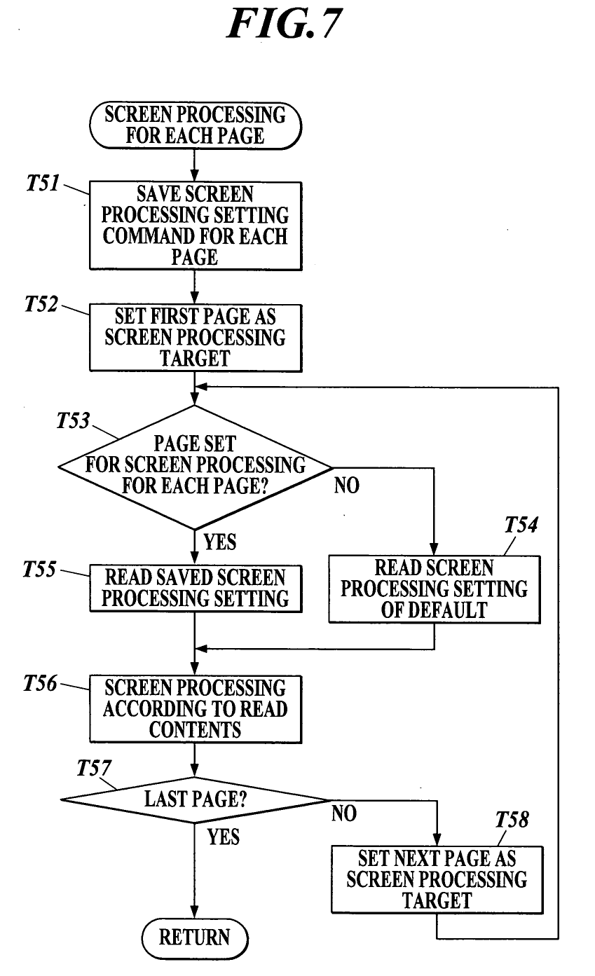

The image forming program 380 is a program for controlling the image forming device 3. According to the embodiment, the image forming program 380 is executed by the control unit 37 to make the image forming device 3 carry out the after-mentioned image forming processing (refer to FIGS. 6 and 7).

Next, an image forming method according to the present invention will be described. FIG. 5 is a flowchart for explaining an operation of image processing parameter setting processing which is executed by reading the printer driver 240 from the storage device 24 by the control unit 25 of the client personal computer 2. FIGS. 6 and 7 are flowcharts for explaining an operation of the image forming processing which is executed by reading the image forming program 380 from the storage device 38 by the control unit 37 of the image forming device 3.

In the image processing parameter setting processing of the client personal computer 2, as shown in FIG. 5, first, when a user specifies image data of a predetermined application file form via the operation unit 22 and enters an image forming instruction (step S1), the control unit 25 converts the image data of the application file form into image data of a page description language (PDL) file form (step S2), and then determines whether the user has instructed screen processing setting for each page (step S3).

When it is determined in the step S3 that the screen processing setting for each page is not instructed (step S3; NO), the control unit 25 sets screen processing parameters for the entire image data by a conventionally known method (step S4), and then proceeds to processing of step S9 described below.

On the other hand, when it is determined in the step S3 that screen processing setting for each page is instructed (step S3; YES), the control unit 25 detects the number of pages for the image data (step S5), and make the display unit 21 display a screen processing setting screen corresponding to the number of pages (step S6).

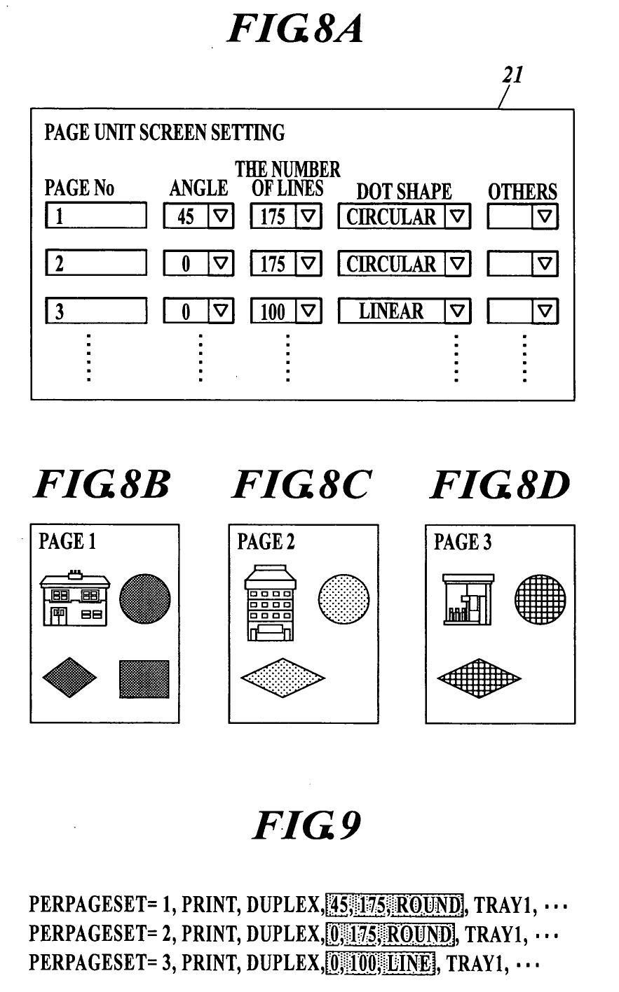

For the screen processing setting screen, for example, a screen shown in FIG. 8A can be used. In this screen processing setting screen, “angle” means a screen angle, “the number of lines” means the number of screen lines, and “dot shape” means a shape of a dot. According to the embodiment, various contents such as the number of screen lines, the screen angle, and the dot shape, i.e., screen processing parameters, can be specified independent from the options displayed in a pull-down menu. However, for the form of the screen processing setting screen, a form in which a plurality of types of screens having predetermined combinations of the screen angle, the number of screen lines, and the dot shape can be directly selected from the pull-down menu, or a form in which each content can be directly entered may be employed.

Then, when the user enters (selects) and sets the screen processing parameters for each page from the pull-down menu via the operation unit 22 (step S7), and when a completion operation of the screen processing setting is performed (step S8), the control unit 25 combines the image data in the PDL form, which is generated in the step S2 with a screen processing setting command corresponding to the screen processing parameters entered in the step S7 to generate a print job (step S9).

In FIG. 8A, as screen processing parameters: a screen angle of a 1st page is 45 degrees, the number of screen lines is 175 lines per inch (lpi), a dot shape is circular; a screen angle of a 2nd page is 0 degrees, the number of screen lines is 175 lpi, and a dot shape is circular; and a screen angel of a 3rd page is 0 degrees, the number of screen lines is 100 lpi, and a dot shape is linear. In this case, for example, a screen processing setting command of the print job is set as indicated by a shaded part in FIG. 9. For a page or an item in which no screen processing setting is executed in the step S7, a screen processing setting command is set as “NONE” (refer to after-mentioned FIG. 11) to instruct the screen processing of a default. FIG. 9 shows a case in which the screen processing setting command is represented by a PCL command. However, other types of commands may be employed.

Then, the control unit 25 transmits the print job to the image forming device 3 via the interface 23 (step S10), and finishes the image processing parameter setting processing.

In the image forming processing of the image forming device 3, as shown in FIG. 6, first, when the print job is received, the job analyzing unit 360 of the print controller 36 starts analysis from the top of the print job (step T1), and detects the screen processing setting command as a screen processing parameter (step T2).

The control unit 37 determines the presence of screen processing setting command for each page (step T3). When it is determined that the screen processing setting command for each page is not present (step T3; NO), the control unit 37 makes the interpreter unit 361 execute rasterization processing and default screen processing (step T4), and then proceeds to processing of step T6 described below.

On the other hand, when it is determined in the step T3 that there are screen processing setting command for each page (step T3; YES), the control unit 37 makes the interpreter unit 361 execute the screen processing for each pages based on the screen processing setting command (step T5).

Specifically, as shown in FIG. 7, first, the control unit 37 stores the screen processing setting command for each page in the storage unit 362 (step T51), and then sets the first page of image data as a target page of screen processing (step T52) .

Then, the control unit 37 determines whether the screen processing setting for each page has been set for the screen processing target page, i.e., a setting other than a default has been set, based on contents of the screen processing setting command (step T53). When it is determined that there is no setting (step T53; NO), the control unit 37 reads the screen processing setting of a default from the storage unit 362 (step T54), and then proceeds to processing of step T56 described below.

On the other hand, when it is determined in the step T53 that the screen processing setting for each page has been set for the screen target page (step T53; YES), the control unit 37 reads the screen processing setting set by a user from the storage unit 362 (step T55).

Then, the control unit 37 makes the interpreter unit 361 execute the screen processing based on the screen processing setting read in the step T54 or T55 (step T56).

The control unit 37 determines whether the screen processing target page is the last page of the image data (step T57). When it is determined that the page is not the last page (step T57; NO), the control unit 37 sets the next page as a screen processing target page (step T58), and then proceeds to the processing of the step T53.

On the other hand, when it is determined in the step T57 that the screen processing target page is the last page (step T57; YES), the control unit 37 finishes the screen processing for each page.

Then, as shown in FIG. 6, the control unit 37 makes the interpreter unit 361 execute rasterization (step T6), transmits the print job to the print engine unit 35 (step T7), then makes the print engine unit 35 execute the printing (step T8), and finishes the image forming processing.

Thus, when the screen processing setting shown in FIG. 8A is set, for example as shown in FIGS. 8B to 8D, images to which different screen processings for each page are applied are printed.

According to the image forming method described above, because the screen processing parameters are set for each page and the screen processing is carried out for each page based on the processing parameters, unlike the conventional case of executing the screen processing for each object type, proper screen processing can be performed for each page.

Because the screen processing can be executed for each page for one image data having a plurality of pages, it is possible to prevent the complication of processing comparing to the case of executing screen processing for a plurality of image data of each page.

Because the screen is set by specifying at least one of the number of screen lines, the screen angle, and the dot shape, it is possible to simplify the processing comparing to the case of specifying all the contents.

Because the screen corresponding to the option selected via the pull-down menu is set for the page, it is possible to simplify the operation comparing to the case of entering contents of screen processing by numerical values or the like.

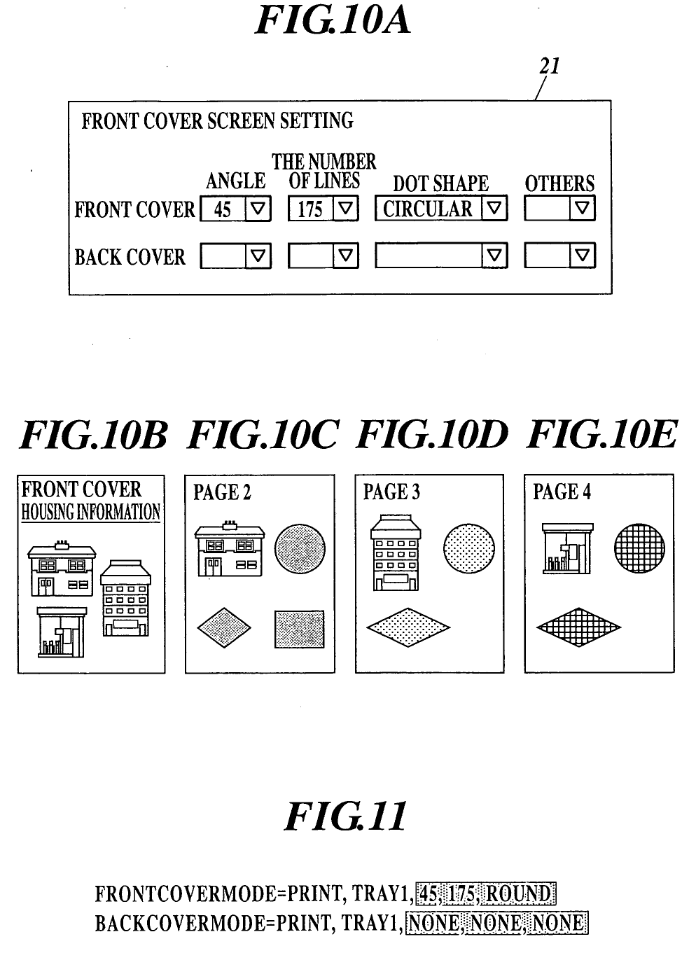

In the above described embodiment, the screen processing setting parameters are input for each page (refer to step S7 of FIG. 5). However, for example, an input may be made to a front cover sheet or a back cover sheet by the screen processing setting screen as shown in FIG. 10A. In this case, as a result of the screen processing setting command being set as the shaded part of FIG. 11, as shown in FIGS. 10H to 10E, it is possible to carry out proper screen processing for the front page even when a sheet which is different in quality is used for a front page.

The present U.S. patent application claims the priority of Japanese Patent Application No. 2006-189442 filed on Jul. 10, 2006, according to the Paris Convention, and the above Japanese Patent Application is the basis for correcting mistranslation of the present U.S. patent application.

What is claimed is:

1. An image processing setting device, comprising:
a screen processing setting unit for setting, on a page-by-page basis, a processing parameter regarding screen processing carried out in an image processing device.

2. An image processing device, comprising:
a parameter detecting unit for detecting, on a page-by-page basis, a processing parameter regarding screen processing; and
a screen processing unit for carrying out the screen processing for each page based on the processing parameter detected by the parameter detecting unit.

3. An image forming system, comprising:
the image processing setting device of claim 1;
an image processing device which comprises a parameter detecting unit for detecting, on a page-by-page basis, the processing parameter regarding the screen processing, and a screen processing unit for carrying out the screen processing for each page based on the processing parameter detected by the parameter detecting unit; and
an image forming device for forming an image for which the screen processing has been carried out by the image processing device.

4. An image processing setting method, comprising:
setting a processing parameter for each page regarding screen processing carried out in an image processing device.

5. An image processing method, comprising;
detecting, on a page-by-page basis, a processing parameter regarding screen processing; and
carrying out the screen processing for each page based on the detected processing parameter.

6. An image forming method, comprising:
setting, on a page-by-page basis, the processing parameter in the image processing setting method of claim 4;
detecting the processing parameter set for each page regarding the screen processing;
carrying out the screen processing for each page based on the detected processing parameter; and
forming an image for which the screen processing has been carried out.

7. An image processing setting device, comprising:
a screen processing setting unit for setting, on a page-by-page basis, a screen applied to screen processing carried out in an image processing device.

8. The image processing setting device of claim 7, wherein
the screen processing setting unit sets the screen by assigning at least one of the number of screen lines, a screen angle, and a dot shape.

9. The image processing setting device of claim 8, comprising:
a display unit for displaying, on a page-by-page basis, at least option regarding at least one of the number of screen lines, the screen angle, and the dot shape; and
an input unit for receiving a selecting operation of the at least one option from a user, wherein
the screen processing setting unit sets for each page the screen corresponding to the at least one option selected by the selecting operation.

10. An image processing setting method, comprising:
setting, on a page-by-page basis, a screen applied to screen processing carried out in an image processing device.

11. The image processing setting method of claim 10, wherein
in the setting, the screen is set by assigning at least either one of the number of screen lines, a screen angle, and a dot shape.

12. The image processing setting method of claim 11, comprising:
displaying, on a page-by-page basis, options regarding at least one of the number of screen lines, the screen angle, and the dot shape; and
receiving a selecting operation of the at least one option from a user, wherein
in the setting, for each page, a screen corresponding to the at least one option selected by the selecting operation are set.
